(19) United States
(12) Patent Application Publication
(10) Pub. No.: US 2026/0288163 A1
(43) Pub. Date: Sep. 24, 2026

(54) DRONE BASED SECURITY AND DEFENSE SYSTEM

(71) Applicant: XTEND Reality Expansion Ltd., Tel Aviv (IL)

(72) Inventors: Aviv Shapira, Tel Aviv (IL); Matteo Shapira, Tel Aviv (IL); Reuven Rubi Liani, Rosh Haayin (IL); Adir Tubi, Be'er Ya'akov (IL)

(21) Appl. No.: 19/677,103

(22) Filed: May 14, 2026

Related U.S. Application Data
(63) Continuation of application No. 17/941,362, filed on Sep. 9, 2022.
(60) Provisional application No. 63/242,061, filed on Sep. 9, 2021.

(51) Int. Cl. G05D 1/689; B64U 10/13; F41H 11/00; G08G 5/34; G08G 5/55; G08G 5/57; B64U 101/31

(52) U.S. Cl. CPC G05D 1/689; B64U 10/13; F41H 11/00; G08G 5/34; G08G 5/55; G08G 5/57; B64U 2101/31; B64U 2201/104; B64U 2201/20

(57) ABSTRACT

Embodiments of the present disclosure may include a method to augment pilot control of a drone, the method including receiving a planned flight route. Embodiments may also include receiving sensor information from an at least one environment sensor along the planned flight route. In some embodiments, the at least one environment sensor may be located at a predefined location. Embodiments may also include estimating a drone location from the sensor information. Embodiments may also include receiving a speed vector of the drone. Embodiments may also include comparing the drone location to an expected drone location along the planned flight route. Embodiments may also include deriving a flight control command and a speed vector command to return the drone to a point along the planned flight route.

### CROSS-REFERENCE TO RELATED APPLICATION

This application is a Continuation of Application No. 17/941,362, filed on September 9, 2022, which claims priority under 35 U.S.C. § 119(e) to U.S. Provisional Application No. 63/242,061, filed on September 9, 2021, all of which are hereby expressly incorporated by reference into the present application.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND

Embodiments of the present invention generally relate to security and defense providing systems. In particular, embodiments of the present invention relate to a drone-based security and defense system for surveilling and detecting security threats at predefined locations both indoors and outdoors, and providing automated as well as remote-controlled security and defense services in the predefined locations from remote locations and/or the predefined locations.

Security systems generally involve monitoring systems that monitor and record activity at predefined locations, alert owner and responders of unusual activities, and trigger alarms. In many instances, owners or responders may be dispatched to the predefined location only to determine that the alarm event is not valid, as the alarm event may be triggered by a malfunction in the system and/or a non-emergent element such as an animal. Thus, monitoring system involves surveillance cameras and surveillance sensors being installed at the predefined locations, and may be accompanied by a video monitoring (VM) server that may frequently monitor security in predefined location. In some situations, surveillance cameras may communicate video feeds of the predefined location to users or owners present at predefined location. In other situations, surveillance sensors may transmit event-based alarm signals to the VM server present at a remote location.

Typically, security systems utilize stationary surveillance camera(s) and/or the surveillance sensor(s), that transmits video feed(s) of the predefined location, and event-based alarm signals to the VM server, which then determines whether a security breach and/or a security threat has occurred. A standard surveillance camera may be able to zoom in to get a closer look; however, the surveillance camera may not be capable of altering the preset field of view to capture activity just outside of range.

Such monitoring systems cannot track activity, follow objects or perform other functions at the predefined location that may be performed by live security personnel. As a result, these monitoring systems are accompanied by security personnel such as guards and police who are alerted upon detection of unusual activity, security threat or intrusion, However, security personnel have limitations on where they can travel, how fast they can respond to a particular situation, and how far and how fast they can reach at the locations and pursue security threats.

Further, it is highly risky and not at all safe for security personnel or owners to directly confront these security threats. In many cases, the intrusion or security threat may be by armed person, terrorists, wild animals, and the likes, which is neither safe for normal people nor even safe for trained security personnel or police to face to face confront and deter or neutralize such high-level security threats.

There is therefore a need to overcome the above shortcomings and provide an improved security and defense system for surveilling and detecting security threats at predefined locations both indoors and outdoors, and which also provides automated as well as remote-controlled security and defense services in the predefined locations, from a remote location as well as the predefined location, with minimal direct physical human interaction to the security threats.

### BRIEF SUMMARY

Embodiments of the present disclosure may include a method to augment pilot control of a drone, the method including receiving a planned flight route. Embodiments may also include receiving sensor information from an at least one environment sensor along the planned flight route. In some embodiments, the at least one environment sensor may be located at a predefined location.

Embodiments may also include estimating a drone location from the sensor information. Embodiments may also include receiving a speed vector of the drone. Embodiments may also include comparing the drone location to an expected drone location along the planned flight route. Embodiments may also include deriving a flight control command and a speed vector command to return the drone to a point along the planned flight route.

Embodiments may also include estimating a drone location from the sensor information may include dynamically learning a weight balance between an active drone sensor and the at least one environment sensor. Embodiments may also include using the weight balance to estimate the drone location from the at least one environment sensor and the active drone sensor.

Embodiments may also include estimating a drone location from the sensor information may include statically configuring a weight balance between an active drone sensor and the at least one environment sensor. Embodiments may also include using the weight balance to estimate the drone location from the at least one environment sensor and the active drone sensor.

Embodiments may also include receiving sensor information from an at least one environment sensor along the planned flight route may include. Embodiments may also include receiving a video feed at a video monitoring (VM)service. Embodiments may also include analyzing frames of the video feed to determine whether at least one of a security breach and a security threat has occurred. Embodiments may also include generating an event-based alarm signal.

In some embodiments, the method may include transmitting the event-based alarm to a virtual reality (VR)display. Embodiments may also include displaying the event-based alarm on the virtual reality (VR)display. Embodiments may also include receiving at least one user command to dispatch the drone to the predefined location. Embodiments may also include presenting an option at the virtual reality (VR)display to either confirm or cancel the event-based alarm.

In some embodiments, the method may include transmitting the event-based alarm to a display. Embodiments may also include displaying the event-based alarm on the display. Embodiments may also include receiving at least one user command to dispatch the drone to the predefined location. Embodiments may also include transmitting an activation signal to the drone. In some embodiments, the activation signal enables a threat handling unit responsive to the event-based alarm. Embodiments may also include activating a threat handling unit may include enabling an actuator of the threat handling unit. In some embodiments, the threat handling unit may be at least one of speakers, one or more lights, a pepper spray, a taser, and a lethal weapon.

Embodiments of the present disclosure may also include a method for managing an event-based alarm from a display, the method including presenting to a user an event-based alarm signal indicative of an unusual activity at a predefined location. Embodiments may also include presenting to a user an option to dispatch a drone to the predefined location. Embodiments may also include receiving a user selection of the option to dispatch the drone to the predefined location. Embodiments may also include receiving a video feed from the drone positioned at the predefined location. Embodiments may also include presenting an option to either confirm or cancel the event-based alarm.

In some embodiments, the method may include receiving a user selection of a drone activation signal. Embodiments may also include transmitting the drone activation signal to the drone. In some embodiments, the drone activation signal enables a threat handling unit responsive to the event-based alarm. Embodiments may also include enabling an actuator of the threat handling unit. In some embodiments, the threat handling unit may be at least one of speakers, one or more lights, a pepper spray, a taser, and a lethal weapon.

In some embodiments, the method may include creating a planned flight route for the at least one drone to maneuver to the predefined location. Embodiments may also include receiving from a second environmental sensor along the planned flight route data indicative of the at least one drone. Embodiments may also include estimating a drone location from second environmental sensor. Embodiments may also include receiving a speed vector of the drone. Embodiments may also include comparing the drone location to an expected drone location along the planned flight route. Embodiments may also include displaying the drone location and the expected drone location along the planned flight route.

In some embodiments, the method may include receiving a set of user input signals to return the drone to the planned flight route. Embodiments may also include deriving a flight control command and a speed vector command in response to the set of user input signals. Embodiments may also include transmitting the flight control command and the speed vector command to the at least one drone. In some embodiments, the flight control command, and the speed vector command to return the drone to a point along the planned flight route.

In some embodiments, the method may include receiving a user selection of a drone activation signal. Embodiments may also include transmitting the drone activation signal to the drone. In some embodiments, the drone activation signal enables a threat handling unit responsive to the event-based alarm. Embodiments may also include enabling an actuator of the threat handling unit. In some embodiments, the threat handling unit may be at least one of speakers, one or more lights, a pepper spray, a taser, and a lethal weapon.

Embodiments of the present disclosure may also include a drone-based security and defense system, the system including at least one drone. Embodiments may also include a first environmental sensor. In some embodiments, the at least one environment sensor may be located at a predefined location. Embodiments may also include a ground control system (GCS).

In some embodiments, the GCS may include one or more processors in communication with a non-volatile memory including a processor-readable media having thereon a set of executable instructions, configured, when executed, to cause the one or more processors to receive an alert signal from the first environmental sensor. Embodiments may also include transmit a set of first signals to activate the at least one drone.

Embodiments may also include create a planned flight route for the at least one drone to maneuver to the predefined location. Embodiments may also include receive from a second environmental sensor along the planned flight route data indicative of the at least one drone. Embodiments may also include estimate a drone location from second environmental sensor.

Embodiments may also include receive a speed vector of the drone. Embodiments may also include compare the drone location to an expected drone location along the planned flight route. Embodiments may also include derive a flight control command and a speed vector command in response to a set of user input signals. Embodiments may also include transmit the flight control command and the speed vector command to the at least one drone. In some embodiments, the flight control command, and the speed vector command to return the drone to a point along the planned flight route. Embodiments may also include perform one or more threat handling operations to deter the one or more security threats.

In some embodiments, the system, may include a virtual reality (VR)display. In some embodiments, the one or more processors in communication with a non-volatile memory including a processor-readable media having thereon a set of executable instructions, further configured, when executed, to cause the one or more processors to receive video feed from the at least one drone. In some embodiments, the video feed may include images of the predefined location. Embodiments may also include transmit to the VR display the video feed.

In some embodiments, the drone may include a global positioning system (GPS)module operatively coupled to the one or more processing units of the GCS. In some embodiments, the GPS module collects a real-time location of the at least one drone. In some embodiments, the system may include at least one of an intrusion and threat detection unit, a flight path management unit, a drone control unit, a video processing, and a VR unit.

In some embodiments, the intrusion and threat detection unit enables the processors to communicate with the first environmental sensor. In some embodiments, the first environmental sensor may be at least one of an IR sensor, a thermal sensor, and a camera. In some embodiments, the first environmental sensor detects one or more security threats.

In some embodiments, the predefined location of the first environmental sensor may be positioned within in an interior location, the system may include at least one standalone device to capture environmental data indicative of the interior location. In some embodiments, the environmental data may be used to create the planned flight route for the at least one drone to maneuver to the predefined location. Embodiments may also include a drone control unit to transmit a set of second control signals to the at least one drone to maneuver the interior location.

In some embodiments, the one or more processors in communication with a non-volatile memory including a processor-readable media having thereon a set of executable instructions, further configured, when executed, to cause the one or more processors to receive a set of video signals from the at least one drone. In some embodiments, the set of video signals may be associated with a video feed of the one or more predefined locations being captured by a camera of the at least one drone. Embodiments may also include transmit the set of digital video signals to a display module associated with the GCS, and a VR headset associated with the one or more users.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a network diagram of the proposed system in accordance with an embodiment of the present invention.

FIG. 2 illustrates a block diagram of the proposed system in accordance with an embodiment of the present invention.

FIG. 3 illustrates a representation of drone architecture in accordance with an embodiment of the present invention.

FIG. 4 illustrates a representation of ground control station architecture in accordance with an embodiment of the present invention.

FIG. 5 illustrates an exemplary view of remote controller for the drones in accordance with an embodiment of the present invention.

FIG. 6 illustrates an exemplary view of VR headset for the drones in accordance with an embodiment of the present invention.

FIG. 7 illustrates an exemplary view of the drone in an outdoor condition in accordance with an embodiment of the present invention

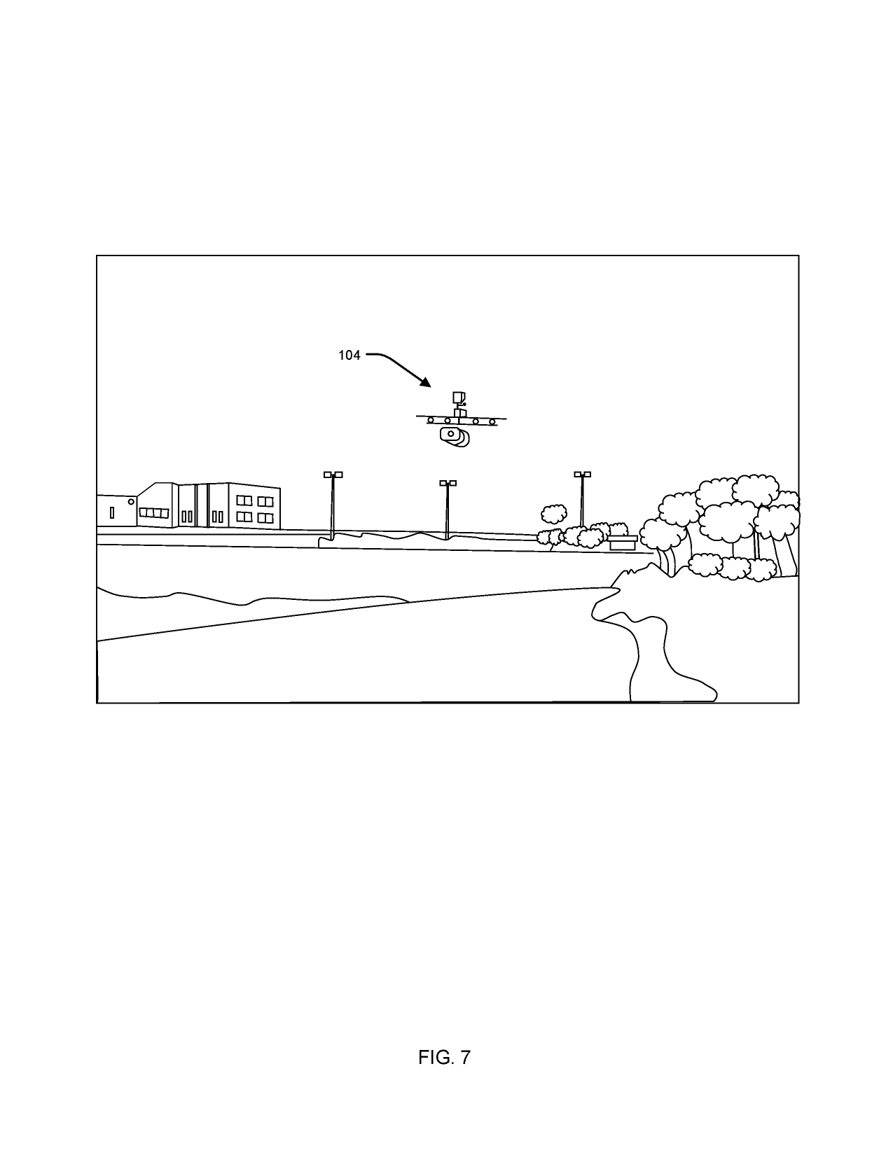

FIG. 8 is a flowchart illustrating a method, according to some embodiments of the present disclosure.

FIG. 9 is a flowchart further illustrating the method from FIG. 8, according to some embodiments of the present disclosure.

FIG. 10 is a flowchart further illustrating the method from FIG. 8, according to some embodiments of the present disclosure.

FIG. 11 is a flowchart further illustrating the method from FIG. 8, according to some embodiments of the present disclosure.

FIG. 12A is a flowchart further illustrating the method from FIG. 8, according to some embodiments of the present disclosure.

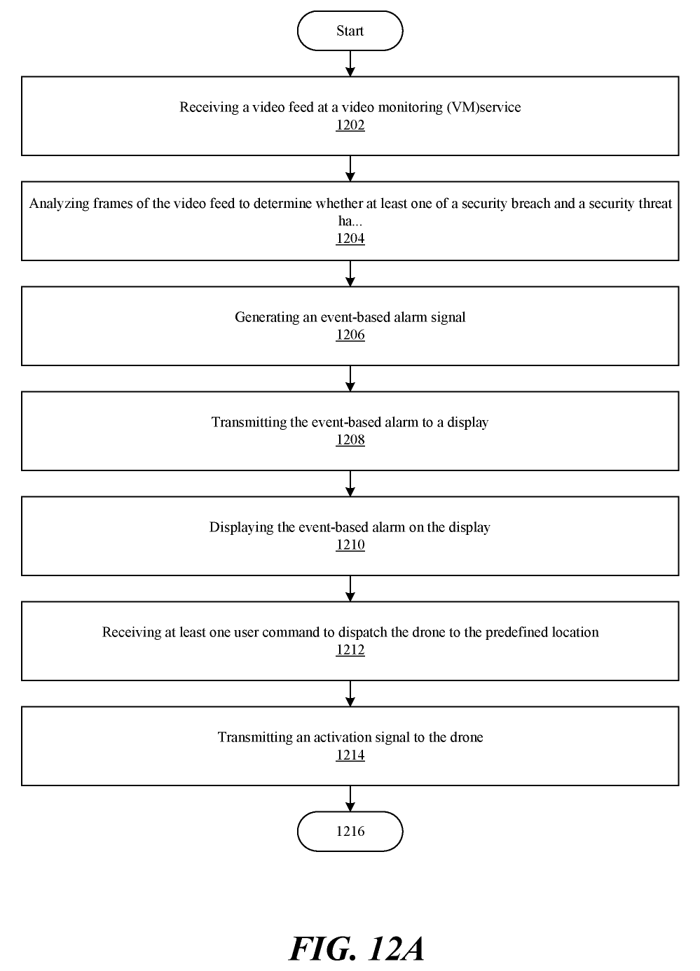

FIG. 12B is a flowchart extending from FIG. 12A and further illustrating the method, according to some embodiments of the present disclosure.

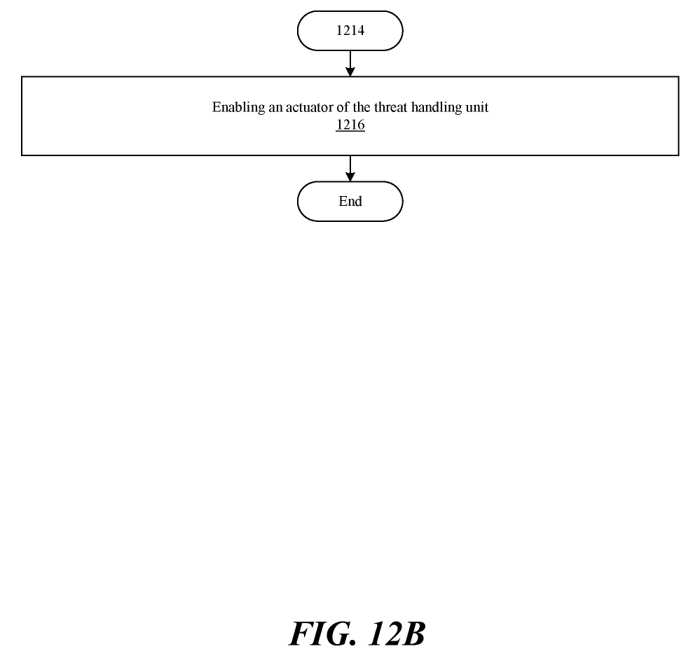

FIG. 13 is a flowchart illustrating a method for managing an event-based alarm, according to some embodiments of the present disclosure.

FIG. 14 is a flowchart further illustrating the method for managing an event-based alarm from FIG. 13, according to some embodiments of the present disclosure.

FIG. 15A is a flowchart further illustrating the method for managing an event-based alarm from FIG. 13, according to some embodiments of the present disclosure.

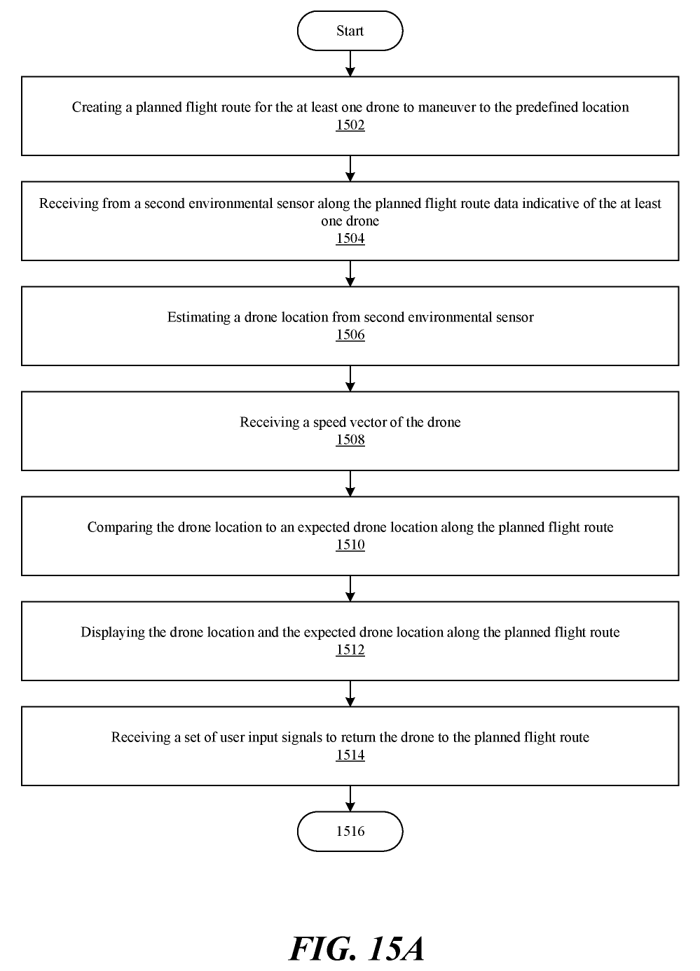

FIG. 15B is a flowchart extending from FIG. 15A and further illustrating the method for managing an event-based alarm, according to some embodiments of the present disclosure.

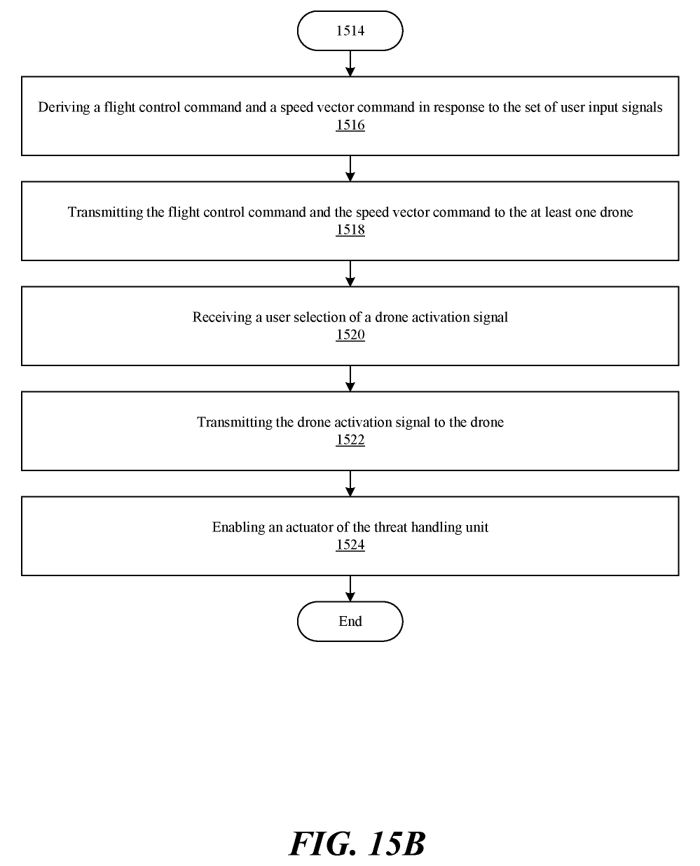

FIG. 16 is a block diagram illustrating a drone-based security and defense system, according to some embodiments of the present disclosure.

FIG. 17 is a block diagram further illustrating the drone-based security and defense system from FIG. 16, according to some embodiments of the present disclosure.

FIG. 18 is a block diagram further illustrating the drone-based security and defense system from FIG. 16, according to some embodiments of the present disclosure.

### DETAILED DESCRIPTION

Provided herein are exemplary embodiment and implementations of the proposed drone-based security and defense system for surveilling and detecting security threats at predefined locations both indoors and outdoors. The system also provides automated as well as remote-controlled security and defense services in the predefined locations, from remote locations and/or the predefined locations.

The disclosed technology provides a system that can detect one or more security threats at predefined locations or dynamic locations that can be an indoor or outdoor area around locations such as home, facilities, streets, public places and the likes. The system can herein, upon detection of security threats at predefined location, allow one or more maneuverable drones (also referred to as UAV or drones, herein) being present at any or a combination of the predefined location or a remote location, to reach at the predefined location and neutralize the security threats. The drones can be controlled and maneuvered using a remote controller or mobile computing devices associated with one or more users who can be present at the predefined location or at a remote location far away from the predefined location. The users can be owner of the predefined location, trained security personnel, police, and the likes.

The disclosed technology provides a virtual reality-based intuitive and immersive experience, making the user feel a telepresence of actually being at the predefined location. The system can include virtual reality (VR) headset (also referred to as VR display or VR glasses, herein) in communication with the drones and the system to provide the immersive VR experience of the predefined location to the user, The system can allow the user to remotely handle, deter, and neutralize the security threats, while actually staying away from the predefined location, using the VR headset and camera of the drones itself. The drones can be remotely configured to perform one or more threat handling operations to deter or neutralize the security threats. In an exemplary embodiment, the one or more threat handling operations performed by the drones can include any or a combination of non-lethal capabilities such as LED signaling and alarm horns, and voice-based instructions provided by the drones, and more deferent capabilities such as flashing lights, loud siren, mace, using pepper spray on intruder or threat, and tasering using taser gun, and the likes.

The disclosed technology also provides a visual interface or display module in communication with the drones that can allow the user to remotely handle, deter, and neutralize the security threats, while actually staying away from the predefined location, using a regular display device, pointer devices such as a mouse or remote controller, and camera of the drones itself. The drones can be remotely configured to perform one or more threat handling operations to deter or neutralize the security threats.

In an embodiment, the system herein, can allow the user to manually control and maneuver the drones using remote controller or mobile computing devices associated with the user, and assess the security of the predefined location, wherever required. In such scenario, the drones can be directly activated and operated without waiting for the system to automatically detect the security threats, and when the drones are in standby mode. In standby mode, the drones can be charged, and battery health as well as system check can be performed on the drones.

In an embodiment, the drones can have the capability to travel in space physically and precisely (3D environments) to reach and travel inside the predefined location. The drones can be sized, adapted and configured to be able to continually compare the location of the drones in physical space to the precise point in the predefined location via proprietary sensor fusion algorithms that allow the drones to estimate the drone’s temporospatial position with great accuracy in variable indoor and outdoor environments. Thus, allowing a minimally trained operator to reach every location within a house or a facility or other dynamic locations with great accuracy.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

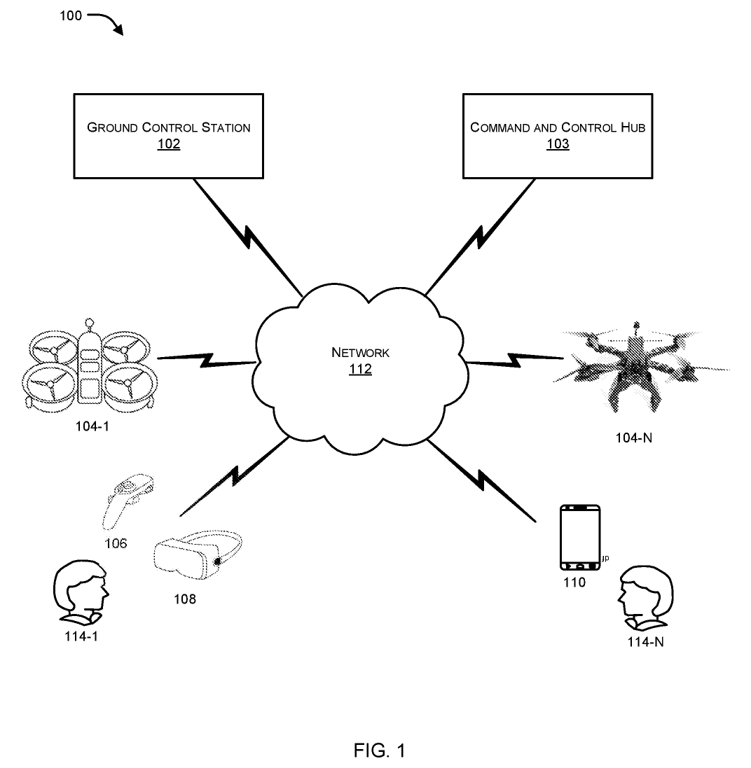

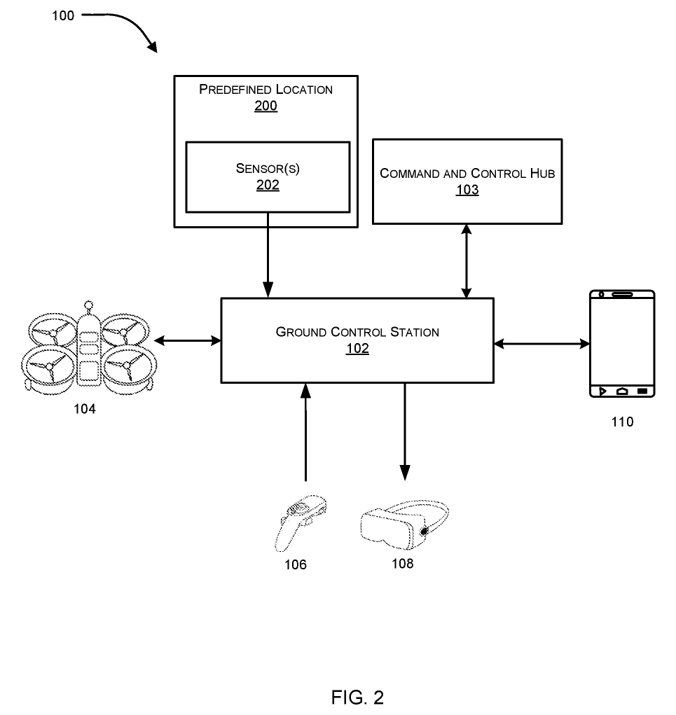

As illustrated in FIG. 1 and 2, the proposed system 100 can include a ground control station (GCS) 102 (also referred to as central processing module (CPM) 102, herein) being positioned at a local onsite predefined location 200 to be protected, and a command and control hub (CCH) 103 (also referred to as command control stations, herein) being positioned at a remote location away from a predefined location 200 or dynamic locations to be protected and secured. The GCS 102 can be communicatively coupled with one or more drones 104-1 to 104-N (individually referred to as drone 104, and collectively referred to as drones 104, herein), and remote controller 106, VR headset 108, and mobile computing devices 110 associated with one or more users 114-1 to 114-N (collectively referred to as user 114, herein), through a network 112. The GCS 102 can directly communicate with the drones 104, and can further allow interaction and communication of the CCH 103 with the drones 104, and remote controller 106, VR headset 108, and mobile computing devices 110. Further, users 114 associated the GCS 102, the CCH 103, and the mobile computing devices 110 can remotely control the drones 104 at the predefined location 200 or dynamic locations, and deter or neutralize the security threats. When the users 114 operate the drones from/within the predefined location 200, the GCS 102 can facilitate the users 114 in controlling the drones 104. In an implementation, the system 100 can be accessed using a virtual private network (VPN) or a server that can be configured with any operating system to provide a secure communication in the system 100.

The mobile computing devices 110 can communicate with the drones 104, the CCH 103, and the GCS 102 through the network 112 regarding controlled operation of the drones 104 by the users 114 to deter or neutralize the security threats. Further, users 114 present at the remote location or at the predefined location 200 can communicate with the drones 104 to get the VR based view of the predefined location 200 using the VR headset 108, and accordingly control the maneuvering and threat handling operations of the drones 104. Furthermore, users 114 present at the remote location or at the predefined location 200 can communicate with the drones 104 to get a real-time camera view of the predefined location 200 using a display of mobile computing devices 110 or general display screen, and accordingly control the maneuvering and threat handling operations of the drones 104 using the mobile computing devices 110, or a general display and pointer devices.

The system can include a first set of sensors 202 (also referred to as first sensors 202, herein) being positioned at desired positions in the predefined location 200. The first sensors 202 can include any or a combination of IR sensor, thermal sensors, cameras, to detect one or more security threat such as intrusion or unauthorized movement or presence of an intruder or animals at the predefined location. The first sensors 202, upon detection of the security threat, can communicate with the GCS 102, the CCH 103, and/or the mobile computing devices 110 of the user, through the network 112, to alert and notify the users regarding the security threats. In an exemplary embodiment, the mobile computing devices 110 can be smartphone, laptop, tablet, computer, and the likes.

In an implementation, upon receiving the alert regarding the security threats, users associated with the GCS 102, the CCH 103 or the mobile computing devices 110, can activate at least one of the drones 104 being present at any or a combination the predefined location 200 or at remote location. The activated drones 104 can reach at the predefined location 200 either manually or using remote controller 106. The drones 104 can travel in space (3D environments) physically and precisely to reach and travel inside the predefined location 200. The drones 104 can be sized, adapted and configured to be able to continually compare the location of the drones 104 in physical space to the precise point in the predefined location 200 via proprietary sensor fusion algorithms that allow the drones to estimate the drone’s temporospatial position with great accuracy in the predefined location. Cameras of the drones 104 can capture a video around the drones 104 in the predefined location, and correspondingly transmit video signals to the GCS 102, CCH 103, and mobile computing devices 110, through the network 112. The GCS 102 or CCH 103 can process the video signals to generate VR based video signals, and can transmit these VR based video signals to the VR headset 108 of the user 114 to provide VR view of the predefined location 200. User 104 can then accordingly control maneuvering of the drones 104 using the remote controller 106. The actuation of one or more buttons of the remote controller 106 by the user 114, can correspondingly transmit a set of control signal to the drones 104, through the network 112, thereby controlling the drones 104 to deter or neutralize the security threats.

In another implementation, upon receiving the alert regarding the security threats, a user 114 present at the predefined location can activate at least one of the drones 104 being present the predefined location 200, using the mobile computing devices 110. The drones 104 can travel in space (3D environments) physically and precisely inside the predefined location 200. The drones 104 can be sized, adapted and configured to be able to continually compare the location of the drones 104 in physical space to the precise point in the predefined location 200 via proprietary sensor fusion algorithms that allow the drones to estimate the drone’s temporospatial position with great accuracy in the predefined location as well as other dynamic locations. Cameras of the drones 104 can capture a video around the drones in the predefined location, and correspondingly transmit video signals to the mobile computing devices 110, though the network 112. User 114 can then accordingly control maneuvering of the drones 104 using any or a combination of the mobile computing device 110, and/or pointer devices such as mouse and remote controller. The mobile computing device 110 can correspondingly transmit a set of control signal to the drones 104, though the network 112, thereby controlling the drones 104 to deter or neutralize the security threats.

In yet another embodiment, the drones 104 can be directly activated and operated without waiting for the system to automatically detect the security threats, when in standby mode, whenever required. The user 114 present at the predefined location can activate at least one of the drones being present the predefined location, using the mobile computing device 110. The activated drones 104 can travel in space (3D environments) physically and precisely inside the predefined location 200. Cameras of the drones 104 can capture a video around the drones in the predefined location, and correspondingly transmit video signals to the mobile computing devices 110. The user 114 can then accordingly control maneuvering of the drones 104 using any or a combination of the mobile computing device 110, and pointer devices such as mouse or remote controller. The mobile computing device 110 can correspondingly transmit a set of control signal to the drones 104, thereby controlling the drones 104 to assess and accordingly deter or neutralize the security threats.

The system 100 can be implemented using any or a combination of hardware components and software components such as a cloud, a server, a computing system, a computing device, a network device and the like. Further, the GCS 102, the CCH 103 can communicatively interact with drones 104, and remote controller 106, VR headset 108, and mobile computing devices 110 associated with users 114 through a secured communication channel provided by communication units such as Wi-Fi, Bluetooth® wireless communication protocol, Li-Fi, or an application, that can reside in the GCS 102, drones 104, and remote controller 106, VR headset 108, and mobile computing devices 110 associated with users 114.

Further, the network 112 can be a wireless network, or a combination of wired and wireless network, that can be implemented as one of the different types of networks, such as Intranet, Local Area Network (LAN), Wide Area Network (WAN), Internet, and the like. Further, the network 114 can either be a dedicated network or a shared network. The shared network can represent an association of the different types of networks that can use variety of protocols, for example, Hypertext Transfer Protocol (HTTP), Transmission Control Protocol/Internet Protocol (TCP/IP), Wireless Application Protocol (WAP), and the like.

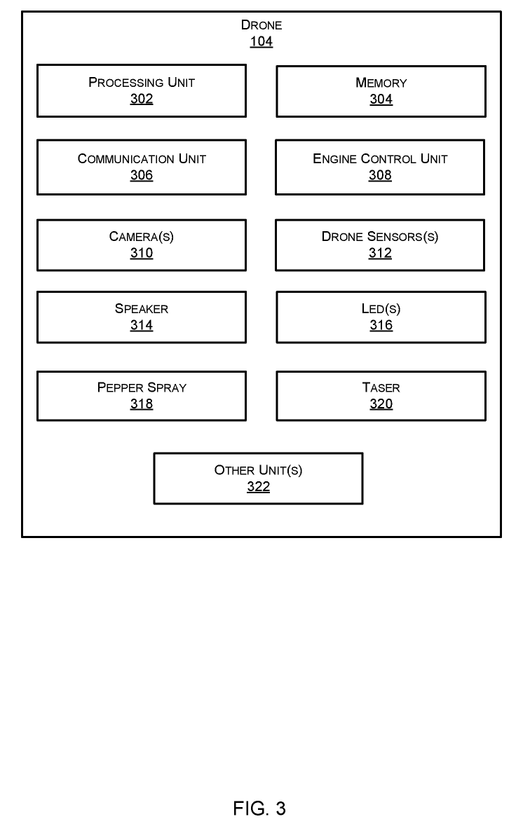

As illustrated in FIG. 3, the drone architecture is illustrated. The drone 104 can include a processing unit 302 comprising processors configured with a processor-readable memory 304 having thereon a set of executable instructions, configured, when executed, to cause the processor to operate the drone 104, and enable communication between the drone 104 and any or a combination of GCS 102, CCH 103, remote controller 106, and mobile computing device 110. The drone 104 can include a communication unit 306 that can be a Radio Frequency (RF) transceiver, or if intended for indoor use, using Bluetooth®, ZigBee®, or cellular networks provided the structure is equipped with the proper beacons. The communication unit 306 can be operatively coupled to the processing unit 302, and configured to communicatively couple the drone 104 with GCS 102, CCH 103, remote controller 106, and mobile computing device 110.

The drone 104 can include an engine control unit 308 comprising engines, propellers, motors, and actuators, but not limited to the likes, being operatively coupled to one another and the processing unit 302, to maneuver and operate the movement of the drone 104. The engine control 308 unit can be operatively coupled to the processing unit 302, and configured to receive a set of control signals from any or a combination of GCS 102, CCH 103, remote controller 106, and mobile computing devices 110, to instruct the engine control unit 308 to maneuver and operate the movement of the drone 104. The drone 104 can stay at a static position inside the predefined location 200. The system 100 can allow the user 114 to toggle between multiple drones. The drone 104 that was toggled-off can remain in a stand-off or hold position where it was, and can later auto-land when out of electrical power or can return to a base station or docking station.

The drone 104 can include camera(s) 310 to capture at least one real-time image or real-time video of an area of interest in the predefined location 200, and correspondingly generate and transmit a set of video signals to any or a combination of GCS 102, and mobile computing device 110. The camera(s) 310 can further comprise analog camera(s), one or more digital cameras, charge-coupled devices (CCDs), a complementary metal-oxide-semiconductor (CMOS) or a combination comprising one or more of the foregoing. If static images are required, the camera can be a digital frame camera. The camera(s) 310 can be night vision camera to allow the drone 104 to capture video and provide live feed of the predefined location 200 at night or in low light conditions.

The drone 104 can further include a second set of drone sensors 312 (also referred to as drone sensors 312, herein)along with the communication unit 306 to maintain two-way communication between the drone 104, and GCS 102, CCH 103, and/or mobile computing device 110. The sensors 312 along with the cameras 310, can continually estimate and assess mismatch between the predefined position 200, and the real position and speed of the drones 104, performing sensor fusion and estimation, and continuously correcting the flight path to match the predetermined flight vector and speed. Sensors 312 can include a 12 degrees of freedom (DOF) sensor reference platform, pressure gauge(s), accelerometers, Lidars, ToF, Sonars, Accelerometers, Gyros, GPS, MonoCam SLAM, StereoCam SLAM. The implementation of the user experience and flight accuracy of the drones can be built upon a proprietary set of algorithms that allows to create both a static and progressive (machine learning, neural network) network of potentially endless sensors disposed on the drone itself and potentially within the flight route, used to adjust and correct the accuracy, precision and resolution of the drone in infinitely complex real-world environments, where each is characterized by different physical attributes such as light, texture, humidity, complexity, aerial pressure, physical barriers, shielding structures and so on. The fusion of the algorithm network is configured to gather and process the information gathered from the environment along the flight route and performs fusion & filtering and performs a prediction (estimation) of where it assess the drone’s location and projected transformation (speed vector), and derives the necessary flight control commands needed to compensate between the predefined location as well as speed vector; and the estimated mismatch to that request. The algorithm networks can statically or dynamically improve the estimation by learning (dynamically) or configuring (statically) the weights (balance) between all active sensors to create the most accurate location and speed vector estimation, to continuously correct the flight patch to reach the predefined location 200.

The drone can 104 include a threat handling unit comprising speakers 314, one or more lights 316 (or LEDs 316), pepper spray 318, taser 320, and shotgun 322, but not limited to the likes, to deter or neutralize the security threats. The speakers 316, LEDs 318, pepper spray 318, taser 320, and shotgun 322, can be operatively coupled with the processing unit 302 through one or more actuators such that the transmission of a set of signals by the GCS 102 or mobile computing device 110, to the processing unit 302 of the drone 104 can enable the one or more actuators to trigger any or a combination of speakers 316, LEDs 318, pepper spray 318, and taser 320, , but not limited to the likes, to deter or neutralize the security threats. In an exemplary embodiment, the one or more threat handling and neutralizing operations being performed by the drone 104 can include any or a combination of non-lethal capabilities such as blue and red light signaling by the LEDs 316, alarm horns by the speaker 314, and voice-based instructions provided by the speaker 314 of the drones, and more deferent capabilities such as flashing lights at the intruder, loud siren generation by speakers 314, mace, using pepper spray on intruder or animals, tasering the intruder using taser 320, and the likes.

In an embodiment, the drone 104 can be communicatively coupled with voice command unit such as ALEXA® or CORTONA^{TM}, and the likes, to allow the user to provide voice commands to manually control operation of the drone 104. The other units 322 of the drone can include a set of batteries operatively coupled to a charging module, to facilitate charging of the drone 104, and allows the drone to operate even when power connection and communication of the drone 104 is lost. The other units 322 of the drone 104 can further include a telemetry Blackbox to store all the captured videos, and flight path data, but not limited to the likes. The drone 104 can be configured with a global positioning system (GPS) module being operatively coupled to the processing unit 302, to monitor real-time, precise and accurate location of the drone 104. The drone 104 can also be configured with a microphone being operatively coupled to the processing unit 302, to sense acoustic signals around the drone 104 at the predefined location 200. The microphone along with speakers 314 can allow the user to communicate with the intruder and/or other personnel at the predefined location 200 and/or dynamic locations.

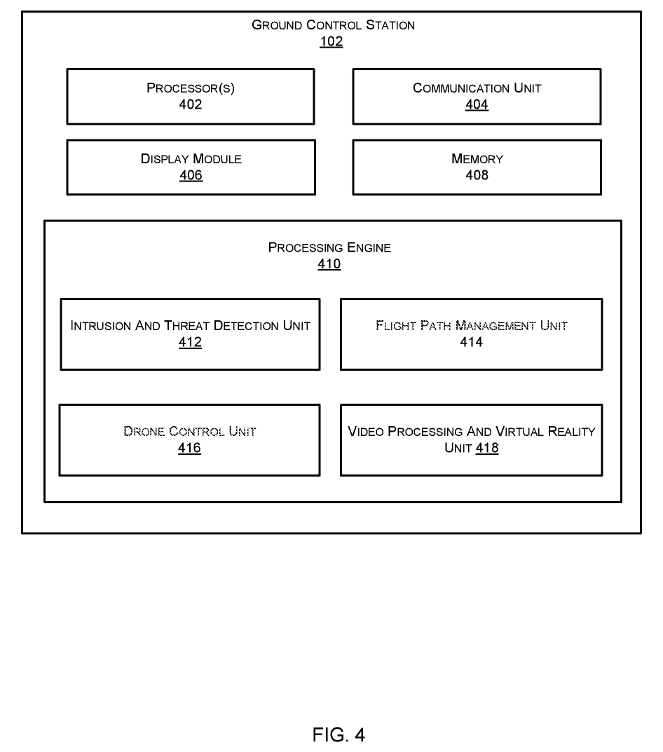

As illustrated in FIG. 4, the ground control station (GCS) 102 can include one or more processor(s) 402. The one or more processor(s) 104 can be implemented as one or more microprocessors, microcomputers, microcontrollers, digital signal processors, central processing units, logic circuitries, and/or any devices that manipulate data based on operational instructions. Among other capabilities, the one or more processor(s) 402 are configured to fetch and execute a set of computer-readable instructions stored in a memory 408 of the GCS 102. The memory 408 can store one or more computer-readable instructions or routines, which may be fetched and executed to create or share the data over a network service. The memory 408 can include any non-transitory storage device including, for example, volatile memory such as RAM, or non-volatile memory such as EPROM, flash memory, and the like

The GCS 102 can include a communication unit 404, which can be a Radio Frequency (RF) transceiver, WIFI Module, but not limited to the likes. The communication unit 404 can be operatively coupled to the processors 402, and configured to communicatively couple the GCS 104 with CCH 103, drones 104, remote controller 106, VR headset 108, and mobile computing device 110. The GCS 102 can also include a display module 406 to provide live and/or recorded feed of video of the predefined location 200, being captured by the cameras 310 of the drones 104. The GCS 102 can also include an interface(s). The interface(s) can include a variety of interfaces, for example, interfaces for data input and output devices, referred to as I/O devices, storage devices, and the like. The interface(s) can facilitate communication between various one or more components of the GCS 102. The interface(s) can also provide a communication pathway for the one or more components of the GCS 102. Examples of such components include, but are not limited to, processing engine(s) 410, communication unit 404, display module 406, memory 408, but not limited to the likes.

The processing engine(s) 410 can be implemented as a combination of hardware and programming (for example, programmable instructions) to implement one or more functionalities of the processing engine(s) 410. In examples described herein, such combinations of hardware and programming may be implemented in several different ways. For example, the programming for the processing engine(s) 410 may be processor-executable instructions stored on a non-transitory machine-readable storage medium and the hardware for the processing engine(s) 410 may include a processing resource (for example, one or more processors), to execute such instructions. In the present examples, the machine-readable storage medium may store instructions that, when executed by the processing resource, implement the processing engine(s). In such examples, the GCS 102 can include the machine-readable storage medium storing the instructions and the processing resource to execute the instructions, or the machine-readable storage medium may be separate but accessible to GCS 102 and the processing resource. In other examples, the processing engine(s) 410 may be implemented by electronic circuitry. The memory can include data that is either stored or generated as a result of functionalities implemented by any of the components of the processing engine(s) 410.

The processing engine(s) 410 can include an intrusion and threat detection unit 412, flight path management unit 414, drone control unit 416, and video processing and VR unit 420, and other engine(s). The other engine(s) can implement functionalities that supplement applications or functions performed by the GCS 102 or the processing engine(s) 410.

The intrusion and threat detection unit 412 can enable the processors 402 to communicate with first sensors 202 being positioned at desired positions in the predefined locations 200. The first sensors 202 can include any or a combination of IR sensor, thermal sensors, cameras, to detect one or more security threat such as intrusion or unauthorized movement or presence of an intruder or animals at the predefined location. The intrusion and threat detection unit 412 can enable the processors 402 of GCS 102 to receive a set of alert signals, generated by the first sensors 202, upon detection of the security threat or intrusion at the predefined location 200. The intrusion and threat detection unit 412 can then accordingly activate the drones to deter or neutralize the security threats, and notify or alert the CCH 103, owner of the predefined location, security personnel, or police, about the security threat.

The flight path control unit 414 can enable the processors 402 to transmit a set of first control signals to at least one of the drones 104 being present at any or a combination the predefined location 200 or at a remote location. The activated drones 104, upon receiving the set of first control signals, can reach at the predefined location 200 either manually or using remote controller 106. The flight path control unit 414 can determine an optimum flight path and speed for the drones to the reach the predefined location 200. The flight path control unit 414 can enable the drones 104 to travel in space (3D environments) physically and precisely to reach at the predefined location 200. The drones 104 can be sized, adapted and configured to be able to continually compare the location of the drones in physical space to the precise point in the predefined location 200 via proprietary sensor fusion algorithms that allow the drones 104 to estimate the drone’s temporospatial position with great accuracy in the predefined location 200. The interior and exterior of the predefined location 200 to be protected can be mapped using standalone devices, or smartphone, and the likes, prior to installation of the drones 104, to facilitate the flight path control unit 414 of GCS 102 to maneuver the drones 104 precisely at the predefined location 200, without hitting anything.

The drone control unit 416 can enable the processors 402 to transmit a set of second control signals to the drones 104 to control the drones 104, based on one or more flight control and maneuvering instructions provided by the user 114, using the remote controller 106. The GCS 102 can be configured to receive a set of commands signals corresponding to one or more flight control and maneuvering instructions provided by the user 114 being present at the predefined location 200 or the CCH 103, through the remote controller 106, and accordingly transmit the set of second control signals to the drones 104. Based on the set of second control signals received, the engine control unit 308 of the drone 104 can maneuver and fly the drone 104 to reach and travel inside the predefined location 200.

The video processing and VR unit 418 can enable the processors 402 of the GCS 102 to receive a set of video signals transmitted by the drones 104. The video processing and VR unit 418 can then enable conversion of the set of video signals into digital video signals. The digital video signals can be stored in memory 408 associated with the GCS 102, and can be transmitted to the CCH 103. Further, the video processing and VR unit 418 can enable the processors 402 to process the video signals to generate VR based video signals, and can transmit these VR based video signals to the VR headset 108 of the user 114 to provide VR view of the predefined location 200, without being physically present at the predefined location 200. The user 114 can then, accordingly control maneuvering of the drones 104 using the remote controller 106 to deter or neutralize the security threat.

In addition, video processing and VR unit 418 can enable conversion of the set of video signals into digital video signals, and can transmit these digital video signals to a display of smartphone, or a general display of the GCS 102, and/or CCH 103, which allows the user to accordingly control the maneuvering and threat handling operations of the drones 104, without being physically present at the predefined location 200.

The display module 406 of the GCS 102 and CCH 103 can include display elements, which may include any type of element which acts as a display. A typical example is a Liquid Crystal Display (LCD). LCD for example, includes a transparent electrode plate arranged on each side of a liquid crystal. There are however, many other forms of displays, for example OLED displays and Bi-stable displays. New display technologies are also being developed constantly. Therefore, the term display should be interpreted widely and should not be associated with a single display technology. Also, the display module may be mounted on a printed circuit board (PCB) of an electronic device, arranged within a protective housing and the display module is protected from damage by a glass or plastic plate arranged over the display element and attached to the housing.

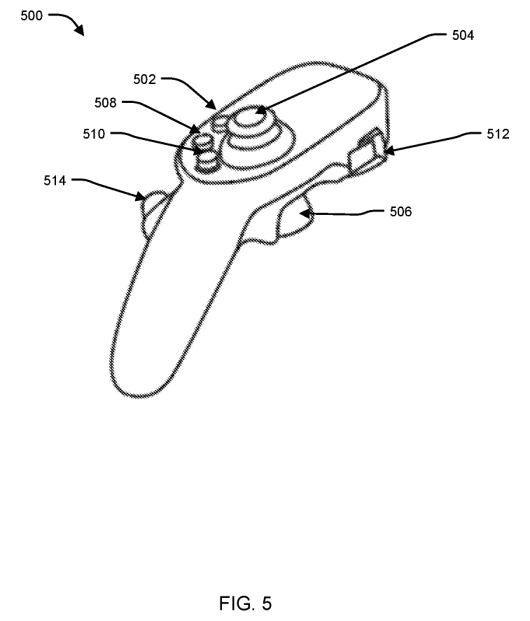

As illustrated in FIG. 5, the remote controller 500 for controlling the drones is disclosed. The remote controller 500 (also referred to as controller 500, herein) can include a RF transceiver to communicate with GCS 102, CCH 103, and drones 104. The transceiver can allow the user to transmit a set of control signals to the drone 104, to maneuver and perform one or more threat neutralizing or handling operations at the predefined location 200.

The controller 500 can include a take-off button 500 to start and take-off the drone 104. The controller 500 can include a joystick 504 that can provide 6 degrees of freedom (DOF), but not limited to the like, to ascend/descend the drone and yaw the drone 104. The controller 500 can include a Mark and Fly (MNF) button 508 that allows the user to fly the drone 104 in a mark and fly mode to automatically or semi-automatically navigate the drone 104 to a marked location. The controller 500 can include a trigger 506 that allows the user to control the speed of the drone 104. To maneuver the drone with MNF mode, the trigger 506 can be pulled to adjust the speed, and the controller 500 can be directed by controlled movement of the controller 500 by user’s hand, to adjust heading of the drone 104.

In addition, upon marking a desired location, the GCS 102 and CCH 103 can develop a flight plan and automatically maneuver the drone 104 to reach at the desired location. The user can press the trigger 506 to increase the speed of the drone 104 during automatic maneuvering also. The controller 500 can also include a landing button 510, which upon actuation by the user for a predefined time, can allow the drone 104 to automatically land or return to a docking station. Further, if required, an arm/disarm button 512 of controller 500 can be toggled to turn on/off the engines of the drone 104. The drone can include a set of threat handling buttons 514, which upon actuation by the user, can trigger any or a combination of LEDs, speaker, pepper spray, taser gun, and the likes, to handle, deter, and neutralize the security threats.

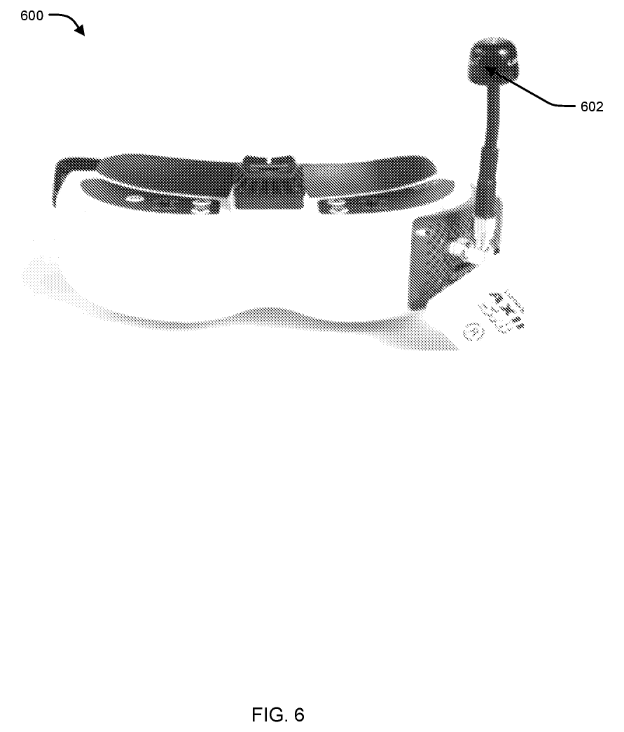

As illustrated in FIG. 6, an exemplary view of the VR headset 600 is illustrated. The VR headset 600 can include a RF receiver 602, to communicate with the drone 104, the CCH 103, and the GCS 102. The VR headset 600 can provide a field of view of 46 degrees diagonal to the user. The VR headset 600 can receive the VR based video signals corresponding to the video being captured by the cameras 310 of the drone 104 in real-time, to give the user a VR based view of the predefined location 200 so that the user can accordingly control the maneuvering and threat handling operations at the predefined location 200 using the drone 104. The VR headset 600 can include an analog DVR with a SD card to provide recording capability to the VR headset.

In an implementation, the VR headset 600 or a display of the mobile computing device 110 can provide the user with map or interactive live VR feed of the predefined location 200, along with interactive VR based feed about locations of all the drones 104, and other functionalities of the drones 104 to select from. The user can use the controller 500 as a selector or cursor on the interactive live VR feed to select and mark a desired location for the drone 104 to reach, using gestures controlled by movement of the controller 500 by hand of the user. The user can further use the controller 500 as a selector on the interactive VR feed of multiple drones to toggle between multiple drones 104-1 to 104-N, and select and take control of at least one of the drones 104, using gestures controlled by movement of the controller 500 by hand of the user. Similarly, the user can use the controller 500 to toggle between other functionalities of drone 104 such as switching between any or a combination of LEDs 316, speaker 314, pepper spray 318, taser 320, and the likes, on the interactive VR feed, to handle, deter, and neutralize the security threats.

Drones 104 can be securely positioned or docked at any or a combination of one or more docking positions at/within the predefined location 200 to be protected, the GCS 102, and at one or more docking stations present away from the predefined location 200. Drone 104 and camera of the drone 104 can be enclosed in a shell so that no drone or cameras are visible to people or intruders unless the drones 104 are activated by the users. Upon activation of drones 104, the shell can automatically open and allow the drones 104 to take-off. The shell can prevent the drones 104 from damage and alteration by unauthorized personnel. The enclosing of the drones 104 and cameras by the shell can provide privacy to the user, as the drones and cameras cannot see anything unless the shell is open and the drones 104 and cameras are activated by user. The docking station can allow secured storage, landing and take-off of drones, as well as allow charging of the drones 104. Further, the GCS 102 can allow secured storage, landing and take-off of drones, as well as allow charging of the drones 104.

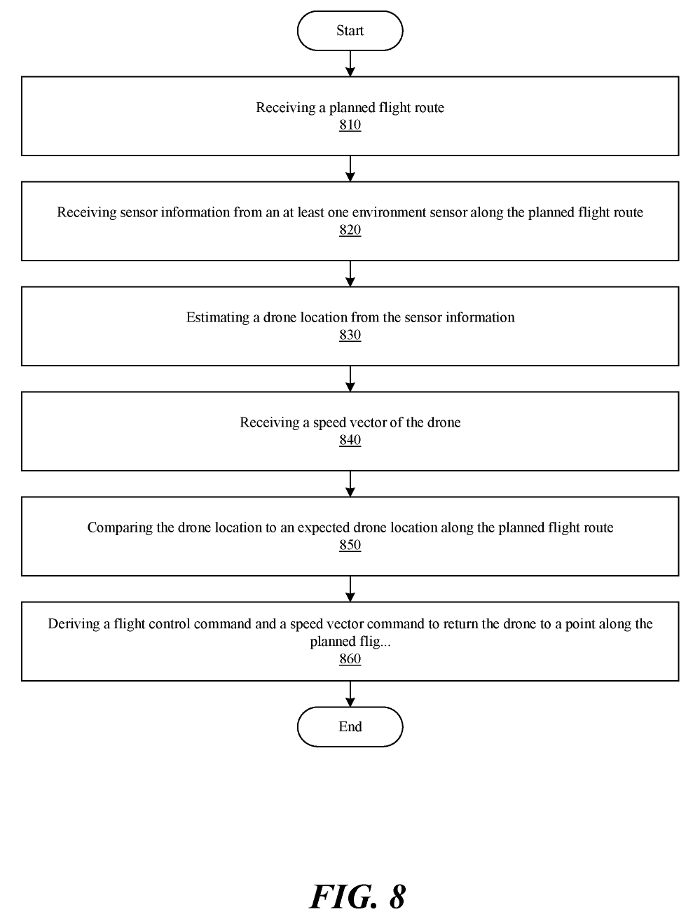

FIG. 8 is a flowchart that describes a method, according to some embodiments of the present disclosure. In some embodiments, at 810, the method may include receiving a planned flight route. At 820, the method may include receiving sensor information from an at least one environment sensor along the planned flight route. At 830, the method may include estimating a drone location from the sensor information. At 840, the method may include receiving a speed vector of the drone. At 850, the method may include comparing the drone location to an expected drone location along the planned flight route. At 860, the method may include deriving a flight control command and a speed vector command to return the drone to a point along the planned flight route. The at least one environment sensor may be located at a predefined location.

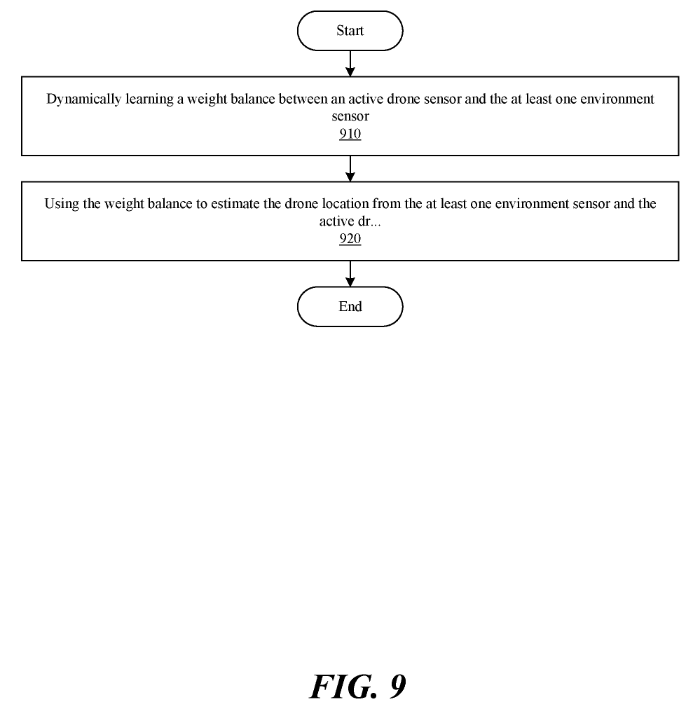

FIG. 9 is a flowchart that further describes the method from FIG. 8, according to some embodiments of the present disclosure. In some embodiments, estimating a drone location from the sensor information further comprises, the method may include 910 to 920.

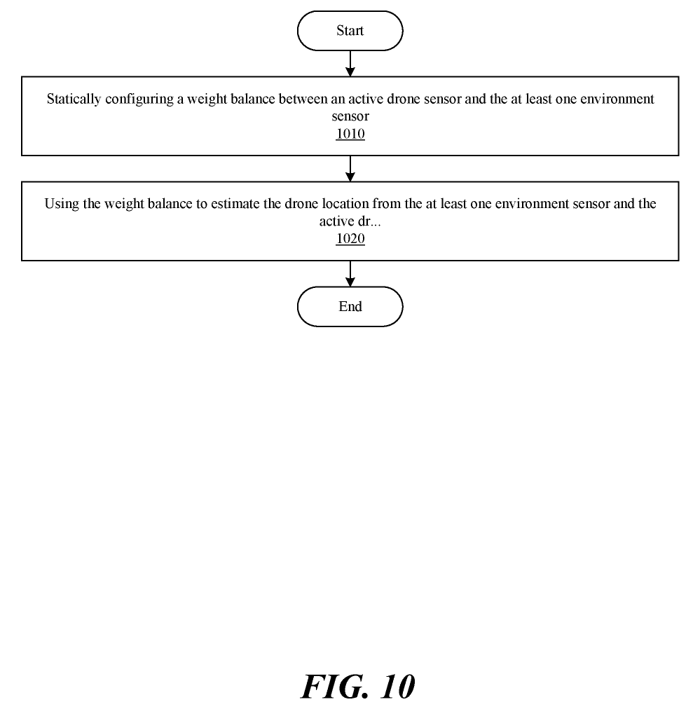

FIG. 10 is a flowchart that further describes the method from FIG. 8, according to some embodiments of the present disclosure. In some embodiments, estimating a drone location from the sensor information further comprises, the method may include 1010 to 1020.

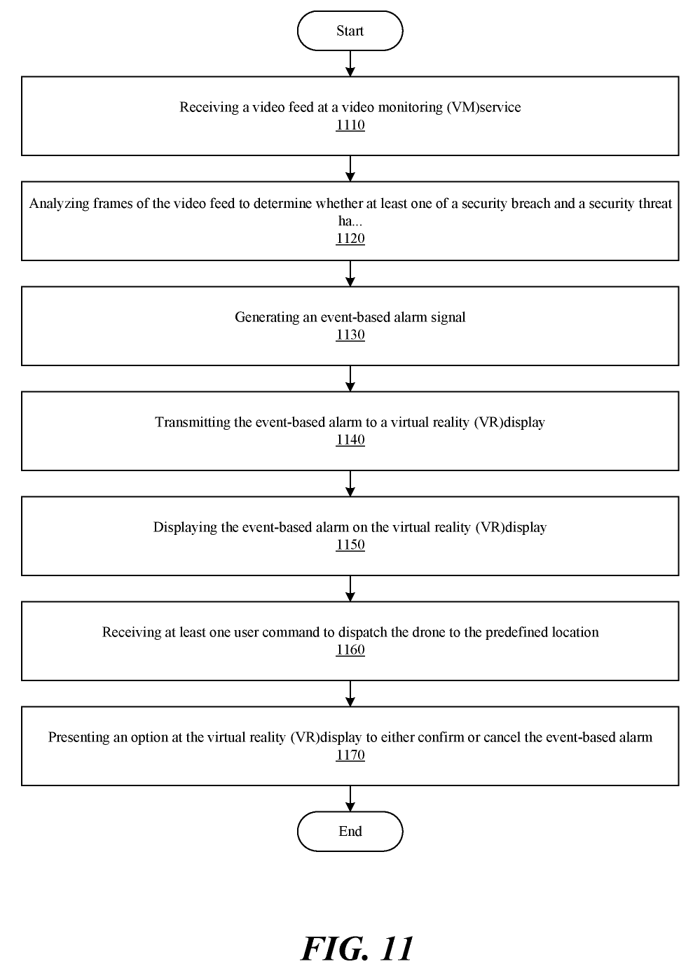

FIG. 11 is a flowchart that further describes the method from FIG. 8, according to some embodiments of the present disclosure. In some embodiments, receiving sensor information from an at least one environment sensor along the planned flight route further comprises. In some embodiments, at 1140, the method may include transmitting the event-based alarm to a virtual reality (VR)display. At 1150, the method may include displaying the event-based alarm on the virtual reality (VR)display. At 1160, the method may include receiving at least one user command to dispatch the drone to the predefined location. At 1170, the method may include presenting an option at the virtual reality (VR)display to either confirm or cancel the event-based alarm.

FIGS. 5A to 5B are flowcharts that further describe the method from FIG. 8, according to some embodiments of the present disclosure. In some embodiments, receiving sensor information from an at least one environment sensor along the planned flight route further comprises. In some embodiments, at 1208, the method may include transmitting the event-based alarm to a display. At 1210, the method may include displaying the event-based alarm on the display. At 1212, the method may include receiving at least one user command to dispatch the drone to the predefined location. At 1214, the method may include transmitting an activation signal to the drone. The activation signal may enable a threat handling unit responsive to the event-based alarm. In some embodiments, activating a threat handling unit further comprises, the method may include 1216. The threat handling unit may be at least one of speakers, one or more lights, a pepper spray, a taser, and a lethal weapon.

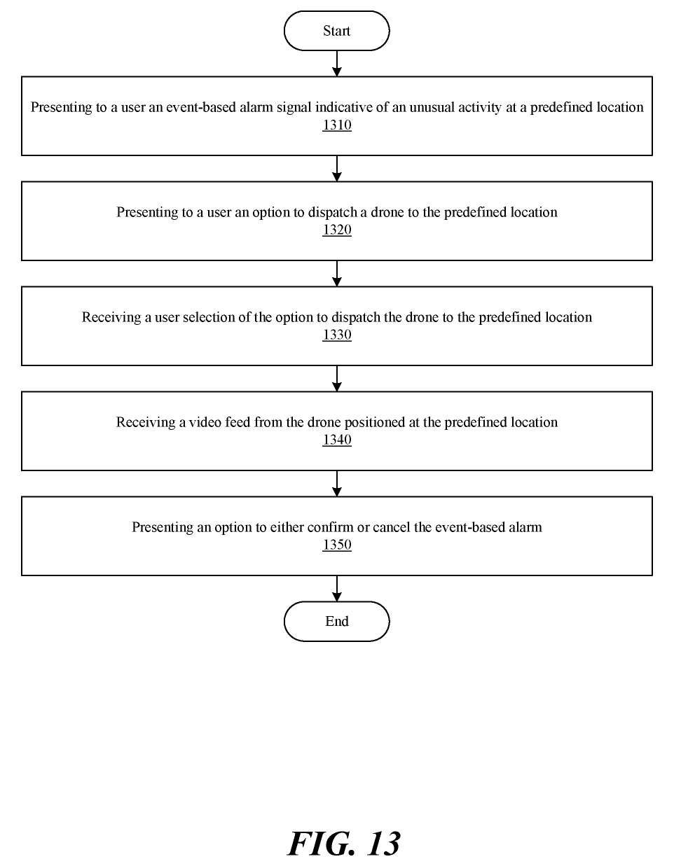

FIG. 13 is a flowchart that describes a method for managing an event-based alarm, according to some embodiments of the present disclosure. In some embodiments, at 1310, the method may include presenting to a user an event-based alarm signal indicative of an unusual activity at a predefined location. At 1320, the method may include presenting to a user an option to dispatch a drone to the predefined location. At 1330, the method may include receiving a user selection of the option to dispatch the drone to the predefined location. At 1340, the method may include receiving a video feed from the drone positioned at the predefined location. At 1350, the method may include presenting an option to either confirm or cancel the event-based alarm.

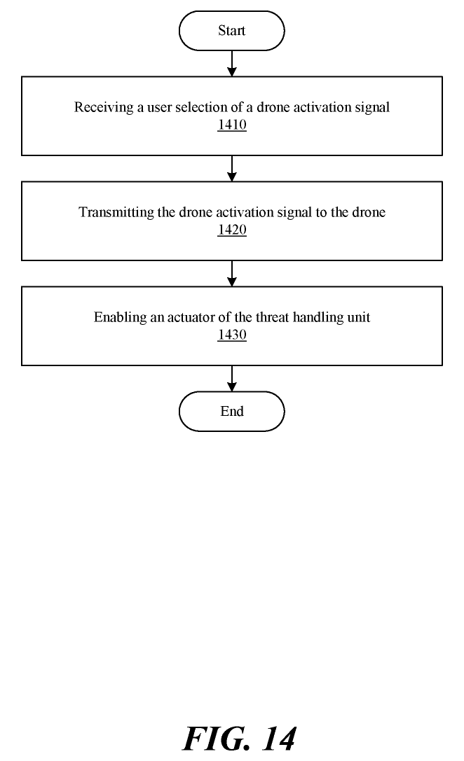

FIG. 14 is a flowchart that further describes the method for managing an event-based alarm from FIG. 13, according to some embodiments of the present disclosure. In some embodiments, at 1410, the method may include receiving a user selection of a drone activation signal. At 1420, the method may include transmitting the drone activation signal to the drone. At 1430, the method may include enabling an actuator of the threat handling unit. The drone activation signal may enable a threat handling unit responsive to the event-based alarm. The threat handling unit may be at least one of speakers, one or more lights, a pepper spray, a taser, and a lethal weapon.

FIGS. 8A to 8B are flowcharts that further describe the method for managing an event-based alarm from FIG. 13, according to some embodiments of the present disclosure. In some embodiments, at 1502, the method may include creating a planned flight route for the at least one drone to maneuver to the predefined location. At 1504, the method may include receiving from a second environmental sensor along the planned flight route data indicative of the at least one drone. At 1506, the method may include estimating a drone location from second environmental sensor. At 1508, the method may include receiving a speed vector of the drone. At 1510, the method may include comparing the drone location to an expected drone location along the planned flight route. At 1512, the method may include displaying the drone location and the expected drone location along the planned flight route.

In some embodiments, at 1514, the method may include receiving a set of user input signals to return the drone to the planned flight route. At 1516, the method may include deriving a flight control command and a speed vector command in response to the set of user input signals. At 1518, the method may include transmitting the flight control command and the speed vector command to the at least one drone. The flight control command and the speed vector command to return the drone to a point along the planned flight route.

In some embodiments, at 1520, the method may include receiving a user selection of a drone activation signal. At 1522, the method may include transmitting the drone activation signal to the drone. At 1524, the method may include enabling an actuator of the threat handling unit. The drone activation signal may enable a threat handling unit responsive to the event-based alarm. The threat handling unit may be at least one of speakers, one or more lights, a pepper spray, a taser, and a lethal weapon.

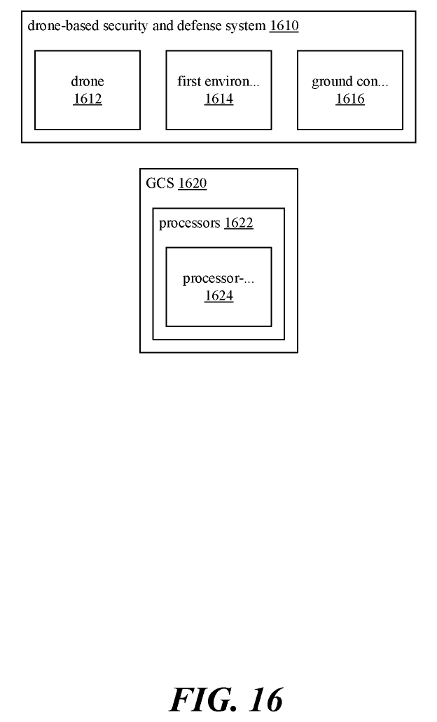

FIG. 16 is a block diagram that describes a drone-based security and defense system 1610, according to some embodiments of the present disclosure. In some embodiments, the drone-based security and defense system 1610 may include at least one drone 1612, a first environmental sensor 1614, and a ground control system 1616 (GCS 1620). The at least one environment sensor may be located at a predefined location. Receive an alert signal from the first environmental sensor 1614. Transmit a set of first signals to activate the at least one drone 1612. Create a planned flight route for the at least one drone 1612 to maneuver to the predefined location.

In some embodiments, receive from a second environmental sensor along the planned flight route data indicative of the at least one drone 1612. Estimate a drone location from second environmental sensor. Receive a speed vector of the drone 1612. Compare the drone location to an expected drone location along the planned flight route. Derive a flight control command and a speed vector command in response to a set of user input signals.

In some embodiments, transmit the flight control command and the speed vector command to the at least one drone 1612. The flight control command and the speed vector command to return the drone 1612 to a point along the planned flight route. Perform one or more threat handling operations to deter the one or more security threats. The GCS 1620 may include one or more processors 1622 in communication with a non-volatile memory. The one or more processors 1622 may include a processor-readable media 1624. Thereon a set of executable instructions, configured, when executed, to cause the one or more processors 1622 to:.

In some embodiments, the at least one drone 1612 may include a global positioning system (GPS)module operatively coupled to the one or more processing units of the GCS 1620. The GPS module may collect a real-time location of the at least one drone 1612. In some embodiments, at least one of an intrusion and threat detection unit, a flight path management unit, a drone control unit, a video processing, and a VR unit.

In some embodiments, the intrusion and threat detection unit may enable the processors 1622 to communicate with the first environmental sensor 1614. In some embodiments, the first environmental sensor 1614 may be at least one of an IR sensor, a thermal sensor, and a camera. The first environmental sensor 1614 may detect one or more security threats. In some embodiments, the one or more processors 1622 in communication with a non-volatile memory. Thereon a set of executable instructions, further configured, when executed, to cause the one or more processors 1622 to:. Receive a set of video signals from the at least one drone 1612. The set of video signals may be associated with a video feed of the one or more predefined locations being captured by a camera of the at least one drone 1612. Transmit the set of digital video signals to a display module associated with the GCS 1620, and a VR headset associated with the one or more users.

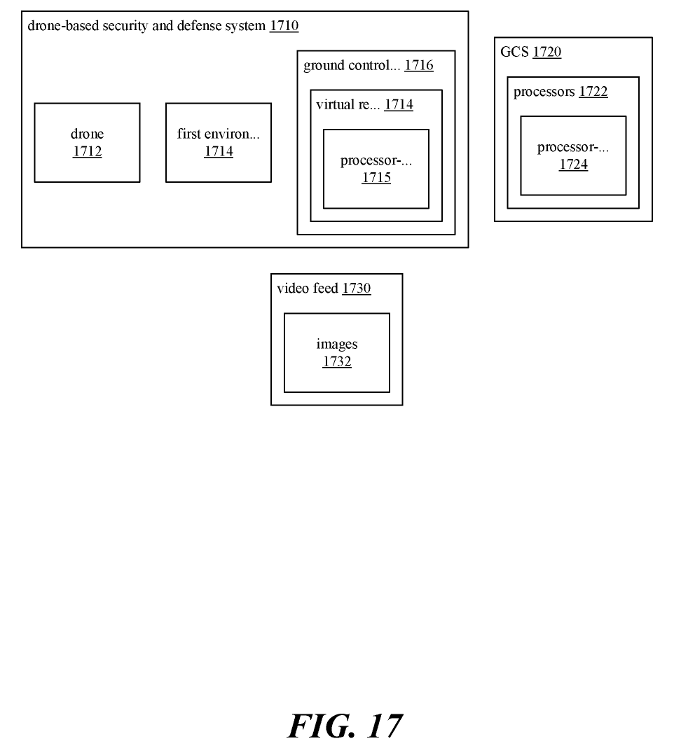

FIG. 17 is a block diagram that further describes the drone-based security and defense system 1610 from FIG. 16, according to some embodiments of the present disclosure. In some embodiments, the ground control system 1616 may include a virtual reality 1714 (VR)display. The virtual reality 1714 may include a processor-readable media 1715. The one or more processors 1622 in communication with a non-volatile memory. Thereon a set of executable instructions, further configured, when executed, to cause the one or more processors 1622 to:. Receive video feed 1730 from the at least one drone 1612. Transmit to the VR display the video feed 1730. The video feed 1730 may include images 1732 of the predefined location.

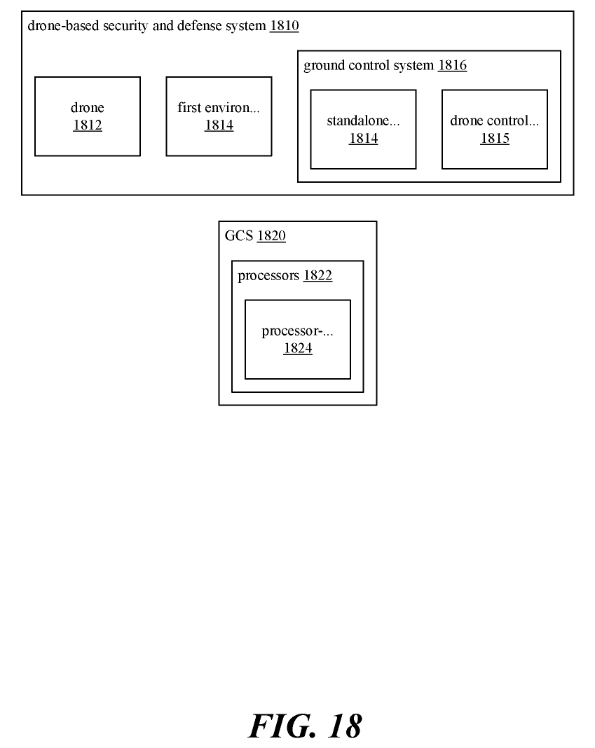

FIG. 18 is a block diagram that further describes the drone-based security and defense system 1610 from FIG. 16, according to some embodiments of the present disclosure. In some embodiments, the predefined location of the first environmental sensor 1614 may be positioned within in an interior location. The ground control system 1616 may include at least one standalone device 1814 to capture environmental data indicative of the interior location and a drone control unit 1815 to transmit a set of second control signals to the at least one drone 1612 to maneuver the interior location. The environmental data may be used to create the planned flight route for the at least one drone 1612 to maneuver to the predefined location.

Accordingly, provided herein is a drone-based security and defense system. The system comprising: a set of first sensors positioned at one or more predefined locations to be secured, the set of first sensors configured to sense one or more security threats at the one or more predefined locations, and correspondingly generate a set of alert signals; one or more drones positioned at any or a combination of the one or more predefined locations, and one or more remote locations; a ground control station (GCS), in communication with a command and control hub (CCH), the one or more drones, the set of first sensors, and one or more input devices associated with one or more users, wherein the GCS comprises one or more processors in communication with a non-volatile memory comprising a processor-readable media having thereon a set of executable instructions, configured, when executed, to cause the one or more processors to: receive the set of alert signals from the set of first sensors, and correspondingly generate a set of first signals to activate at least one of the one or more drones; develop a route plan for the at least one drone towards the one or more predefined locations, in a three-dimensional (3D) physical space; maneuver the at least one drone to the one or more predefined locations in the 3D physical space while simultaneously estimating the location of the at least one drone in a complex environment; wherein, in response to a set of input signals received from the one or more input devices associated with the one or more users, the one or more processors transmit a set of control signals to the at least one drone to maneuver the at least one drone in the one or more predefined locations, and perform one or more threat handling operations to deter the one or more security threats.

In an embodiment, the one or more processors are configured to: receive a set of video signals from the at least one drone, wherein the set of video signals is associated with a video feed of the one or more predefined locations being captured by a camera of the at least one drone, and correspondingly generate any or a combination of a set of digital video signals, and a set of virtual reality (VR) based video signals; transmit the set of digital video signals to any or a combination of a display module associated with the GCS, and the CCH, and one or more mobile computing devices associated with the one or more users; and transmit the set of VR based video signal to a VR headset associated with the one or more users.

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

As used herein, and unless the context dictates otherwise, the term "coupled to" is intended to include both direct coupling (in which two elements that are coupled to each other contact each other) and indirect coupling (in which at least one additional element is located between the two elements). Therefore, the terms "coupled to" and "coupled with" are used synonymously. Within the context of this document terms "coupled to" and "coupled with" are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C …. and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

What is claimed is:

1. A method for managing an event-based alarm from a display, the method comprising:
a. presenting to a user an event-based alarm signal indicative of an unusual activity at a predefined location;
b. presenting to a user an option to dispatch a drone to the predefined location;
c. receiving a user selection of the option to dispatch the drone to the predefined location;
d. receiving a video feed from the drone positioned at the predefined location; and
e. presenting an option to either confirm or cancel the event-based alarm.

2. The method of claim 1, further comprising:
a. receiving a user selection of a drone activation signal;
b. transmitting the drone activation signal to the drone, wherein the drone activation signal enables a threat handling unit responsive to the event-based alarm; and
c. enabling an actuator of the threat handling unit, wherein the threat handling unit is at least one of speakers, one or more lights, a pepper spray, a taser, and a lethal weapon.

3. The method of claim 1, further comprising:
a. creating a planned flight route for the at least one drone to maneuver to the predefined location;
b. receiving from a second environmental sensor along the planned flight route data indicative of the at least one drone;
c. estimating a drone location from second environmental sensor;
d. receiving a speed vector of the drone;
e. comparing the drone location to an expected drone location along the planned flight route; and
f. displaying the drone location and the expected drone location along the planned flight route.

4. The method of claim 3, further comprising:
b. deriving a flight control command and a speed vector command in response to the set of user input signals;
c. transmitting the flight control command and the speed vector command to the at least one drone, wherein the flight control command and the speed vector command to return the drone to a point along the planned flight route.

5. The method of claim 3, further comprising:
a. receiving a user selection of a drone activation signal;
b. transmitting the drone activation signal to the drone, wherein the drone activation signal enables a threat handling unit responsive to the event-based alarm; and
c. enabling an actuator of the threat handling unit, wherein the threat handling unit is at least one of speakers, one or more lights, a pepper spray, a taser, and a lethal weapon.
